(19) United States
(12) Patent Application Publication
(10) Pub. No.: US 2005/0104379 A1
(43) Pub. Date: May 19, 2005

(54) Wind-driven generator

(76) Inventor: John S. Haskill, Port Hope (CA)

Correspondence Address: BIRCH STEWART KOLASCH & BIRCH, PO BOX 747, FALLS CHURCH, VA, 22040-0747, US

(21) Appl. No.: 10/989,511

(22) Filed: Nov. 17, 2004

(30) Foreign Application Priority Data
Nov. 18, 2003 (CA) 2,449,575

(51) Int. Cl. F03D 9/00; H02P 9/04; F03B 13/10; F03B 13/12

(52) U.S. Cl. 290/44

(57) ABSTRACT

A wind-driven apparatus for generating power has a housing provided with an inlet and outlet at the upstream and downstream ends respectively. Louvers are provided at the inlet for controlling the volume of air which flows through the inlet. Air within the housing activates a fan and one or more gates and windows, also within the housing act, as a by-pass for diverting a selected portion of the flow of air away from the fan. The fan is connected to and drives a generator.

### FIELD OF THE INVENTION

This invention relates to an apparatus for generating power by means of wind and more particularly to an apparatus in which the flow of air activates a generator. The apparatus has means for controlling the volume of air which passes through the apparatus as well as means for diverting a selected portion of air within the apparatus from activating the generator.

### BACKGROUND OF THE INVENTION

Generators which harness the energy from moving air to produce power are well known. For example, it is also known to mount generators on motor vehicles and to activate them by fans which are positioned in the stream of air through which the vehicles pass as they move forward. The fans are known to be positioned on the roof of the vehicles, beneath their front hoods or wherever else they will be exposed to the wind. Electrical energy produced by the generators are used to charge the batteries of the vehicles.

A shortcoming of many known wind-powered generators is that there is little or no effective way to control the flow of air which activates the generator. Such control is necessary because the force of a wind, if it is too strong or varies too widely over a short period of time, can damage or impair the effectiveness of the generator. Such force, however, inherently varies widely. The strength of the wind will depend on a number of factors such as the speed of the vehicle and the strength of the wind through which the vehicle is travelling. As well the wind force will vary if the wind is gusty and if the vehicle is not travelling at a constant velocity. These variations must be moderated or dampened if a generator is to operates efficiently.

### SUMMARY OF THE INVENTION

I have invented a wind-driven power generating apparatus which has a simple but very effective means for controlling the strength of the wind which activates it. By means of louvers, gates and windows, I control the volume of the stream of air which activates the generator and the pressure of air within the apparatus. Briefly my apparatus includes a housing having upstream and downstream ends and an inlet disposed at the upstream end for receiving a flow of air from outside the housing. There is means for controlling the volume of air which flows through the inlet and there is a fan mounted within the housing. There is also a by-pass for diverting a selected portion of the flow of air away from the fan and a generator operatively connected to the fan for rotation by the fan.

### DESCRIPTION OF THE DRAWINGS

The wind-driven power generating apparatus of my invention is described with reference to the accompanying drawings in which:

FIG. 1 is a perspective view, partly cut away, of the apparatus;

FIG. 2 is a perspective view of the housing within which a second embodiment of the apparatus is mounted;

FIG. 3 is a schematic plan view of the interior of the second embodiment of the apparatus;

FIG. 4 is a perspective view, in enlarged scale, of baffles with which the apparatus of FIGS. 2 and 3 is provided;

FIG. 5 is an elevation of gates with which the apparatus of FIGS. 2 and 3 is provided; and

FIG. 6 is an another elevation of the gates of FIG. 5.

Like reference characters refer to like parts throughout the description of the drawings.

### DESCRIPTION OF PREFERRED EMBODIMENTS

With reference to FIG. 1, the wind-driven apparatus of my invention, generally 10, has a cylindrical housing 12 having upstream and downstream ends 14, 16, respectively. An inlet 18 is formed at the upstream end for receiving a flow of air from outside the housing.

A number of louvers 20 are mounted on the inlet. The louvers are pivotal from open to closed positions so that the volume of air which flows into the housing can be controlled. The apparatus for causing the louvers to pivot is conventional and is not described herein.

The housing has a hollow cylindrical inner wall 22 in which is mounted a duct 24 for directing or restricting the flow of air through the housing. The duct has a frusto-conical portion 26 which commences at the inner wall, closes downstream and terminates at a hollow cylindrical portion 28 which extends further downstream. A by-pass in the form of windows 30 open and close openings in the frusto-conical portion of the baffle. The apparatus for operating the gates is conventional and is not illustrated.

A fan 34 is mounted centrally for rotation within the cylindrical portion of the duct. The fan is caused to rotate by air which flows through the inlet. Mounted downstream of the fan is a conventional generator 36 which is connected to the fan by rod 38. The rod is mounted in bearings and transfers rotary motion from the fan to the generator. The generator acts as a source of electrical current and may be electrically connected by means of cable 40 to the battery (not illustrated) of a motor vehicle in order to recharge the battery.

Air which flows through the housing discharges through outlet 16.

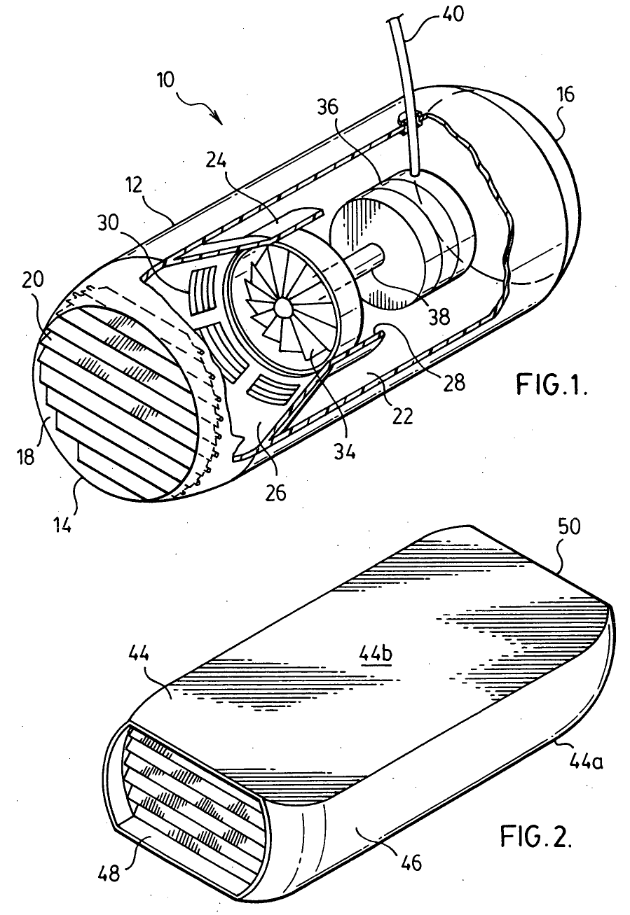

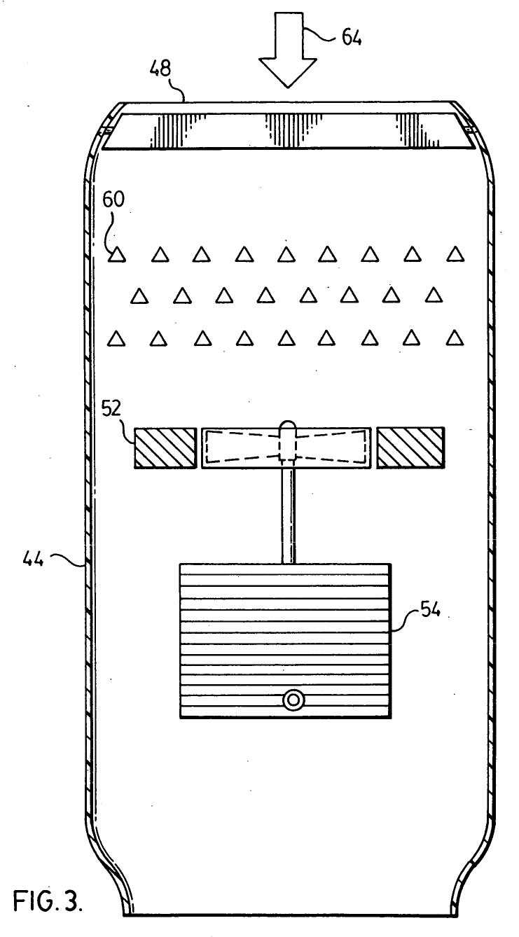

With reference to FIGS. 2 and 3, the wind-driven apparatus is mounted within a housing 44 having flat lower and upper walls 44a, b and curved side walls 46. The housing has an inlet 48 for a stream of air and an outlet 50. A fan 52 and a generator 54 are mounted in the interior of the housing. The fan and generator have the same structure as the fan and generator of the first embodiment of the apparatus illustrated in FIG. 1.

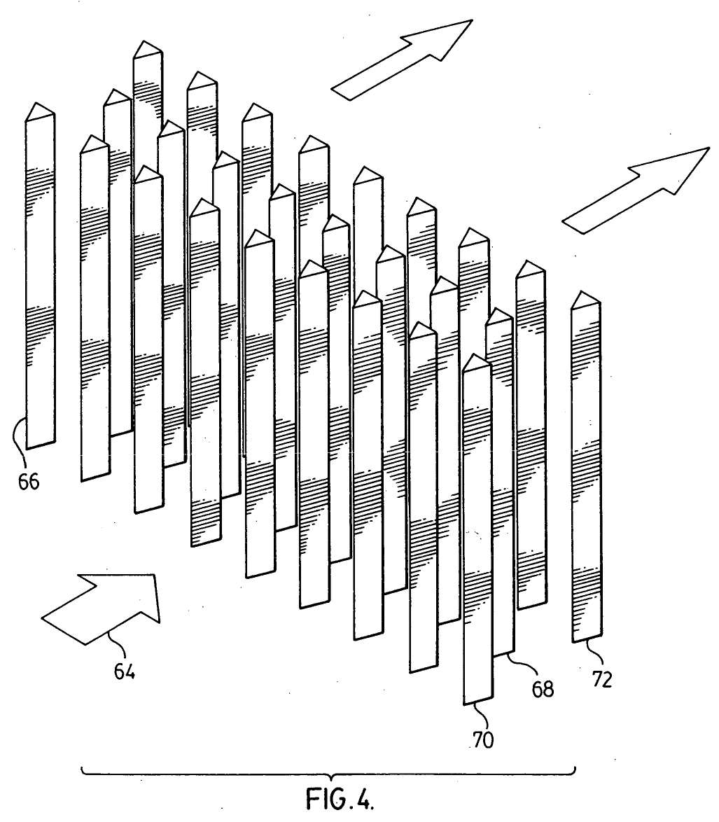

With reference to FIGS. 3 and 4, mounted upstream of the fan is a number of baffles 60 arranged in parallel rows oriented transversely to the direction of flow of air indicated by arrows 64. Each baffle has a triangular cross-section and is mounted such that one of its vertices 66 forms the leading edge of the baffle and is first to contact the air after it flows past the louvers at the inlet of the apparatus.

The baffles act to retard the flow of air. To this end, there is a baffle in the second row 68 downstream of the space between adjacent spoilers in the first or upstream row 70. Similarly, there is a baffle in the third or downstream row 72 downstream of the space between adjacent baffles in the second row. Thus there is no straight passage of air through the rows. The air as it flows through the rows of baffles will be diverted and hence its rate of flow will inevitably be reduced by the baffles. In other words, the baffles in each row downstream of the most upstream row 70 divert the flow of air from the row closest thereto upstream thereof.

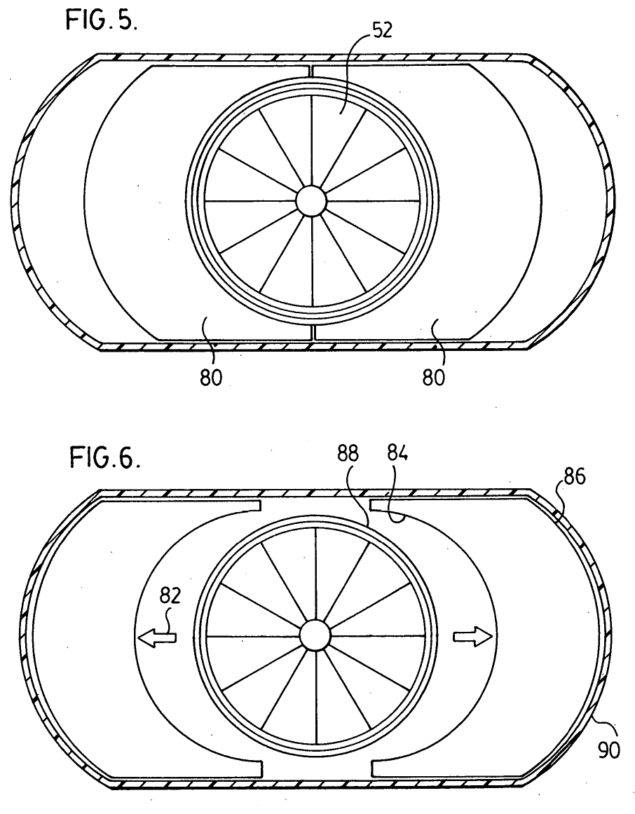

With reference to FIGS. 5 and 6, on either side of fan 52 is a gate 80. The gates are mounted on tracks (not illustrated) and are movable in the direction of arrows 82 toward and away from the fan. Each gate has an inside concave edge 84 and an outer convex edge 86. The inner edge conforms to the shape of the outer wall 88 of the fan housing while the outer edge 86 conforms to the shape of the outer wall 90 of the housing of the housing.

The gates serve to direct the flow of air toward the central area of the interior of the housing or away from the central area and toward the outer wall of the housing. The position of the gates will determine where the air flows and what the pressure of the air is within the housing. The position can be adjusted by means (not illustrated) from outside the housing.

The apparatus illustrated in FIG. 1 is particularly suitable for use in a motor vehicle while the apparatus illustrated in the remaining Figures is particularly suitable for use in a light aircraft.

It will be understood of course that modifications can be made in the wind-driven apparatus of the invention without departing from the scope and purview of the invention as defined in the appended claims.

1. A wind-driven power generating apparatus including: a housing having upstream and downstream ends and an inlet disposed at the upstream end for receiving a flow of air from outside said housing; means for controlling the volume of air which flows through said inlet; a fan mounted for rotation within said housing and caused to rotate by said flow of air; a by-pass for diverting a selected portion of said flow of air away from said fan; and a generator operatively connected to said fan for rotation thereby.

2. The apparatus of claim 1 wherein said controlling means includes a plurality of spaced louvers movable to alternatively increase and diminish the flow of air which flows therebetween.

3. The apparatus of claim 1 further including a duct through which air from said inlet flows to said fan, said duct tapering downstream of said housing, said by-pass being mounted to said duct.

4. The apparatus of claim 3 wherein said duct is a funnel having a frusto-conical component which tapers downstream of said housing and which terminates at a hollow cylindrical component which extends further downstream, said fan being mounted within said cylindrical component and being spaced radially inward therefrom.

5. The apparatus of claim 3 wherein said by-pass is a window adapted to open and close in order to divert a selective portion of said flow of air away from said fan.

6. The apparatus of claim 4 wherein said by-pass is a window formed in said frusto-conical component and adapted to open and close in order to divert a selective portion of said flow of air away from said fan.

7. The apparatus of claim 1 further including a plurality of baffles disposed in the flow of air upstream of said fan.

8. The apparatus of claim 7 wherein said baffles are arranged in a plurality of rows each extending transversely of the direction of the flow of air, the baffles in each said row downstream of the most upstream row diverting the flow of air from the row closest thereto upstream thereof.

9. The apparatus of claim 1 wherein said housing has an interior wall which defines a passage through which air flows, said apparatus further including a gate extending transversely of the direction of the flow of air and selectively movable toward and away from said interior wall in order to direct the flow of air alternatively toward the centre of said housing and toward the outer wall of said housing respectively

10. The apparatus of claim 1 wherein said housing has an interior wall which defines a passage through which air flows, said apparatus further including a pair of gates which extend transversely of the direction of the flow of air and which are disposed on opposite sides of said fan, said gates being selectively movable toward and away from said interior wall in order to direct the flow of air alternatively toward the centre of said housing and toward the outer wall of said housing respectively.
